(19) United States
(12) Patent Application Publication
(10) Pub. No.: US 2008/0000411 A1
(43) Pub. Date: Jan. 3, 2008

(54) Protective barrier for a golf course flag stick

(76) Inventor: Tyler Easterwood, Austin, TX (US)

Correspondence Address: Richard J. Hammond, 5218 Riverbend Blvd., Baton Rouge, LA, 70820, US

(21) Appl. No.: 11/480,805

(22) Filed: Jul. 3, 2006

(51) Int. Cl. G09F 17/00

(52) U.S. Cl. 116/173

(57) ABSTRACT

The present invention is directed toward the provision of a barrier for protecting and isolating the poles or flag sticks, used on golf courses to mark the position of the hole in a golf course green, from ambient environmental damage and damage that may occur from workers or golfers handling of such poles or flag sticks.

### BACKGROUND OF THE INVENTION

The present invention relates to a barrier material that can be applied to a flag stick, such flag stick being used to mark the position of the hole on the green of a golf course. More particularly, the invention relates to a synthetic plastic enclosing material that is applied to a flag stick along substantially its entire length. The synthetic plastic enclosing material is fitted by shrink wrapping it on the flag stick.

The protection of poles and related pole-like objects from environmental degradation has previously been carried out by treatment with various chemical compounds. For example, chromated copper arsenate (CCA) has been used successfully in the past for preserving wood products from environmental degradation. Chloropicrin and pentachlorophenol have also found use as preservatives for such materials.

While poles and stick-like materials are preserved by the use of chemical treatments as illustrated above, the preserving agents are quite toxic. Handling of the treated materials must be done with care and disposal of the treated materials into the environment is difficult.

Fiberglass is a satisfactory alternative to wood in flag stick applications. However, it is considerably more expensive than wood. Additionally, items manufactured from fiberglass suffer from ultraviolet and oxidative damage causing cracking and brittleness, thereby decreasing their useful life. They also appear to be more susceptible to gouging and other surface damage than wooden flagsticks.

Thermo-shrinkable materials have been generally used for covering or parceling of, for example, vessels, bottles (including plastic bottles), tubes, pipes, rods and the like especially for partially or integrally covering the caps, shoulders, bulges, etc. of such materials for the purpose of improving their commercial and aesthetic value. Such materials have also found application in packaging such as of boxes, plates, bottles, etc. or skin-packaging where the film is adhered onto the unpacked material and then shrunk in place.

Some efforts have been made to wrap poles near ground level for pole protection. See, for example, U.S. Pat. Nos. 1,982,569 and 2,724,156. Pole supports having protection at the bottom are disclosed in U.S. Pat. No. 982,380.

However, flag sticks that are used on golf courses require special consideration. Over a period of time, these poles suffer from mechanical and environmental damage. Not only do they become unattractive from fading and flaking of the coloring materials, but they also become cracked and splintered, often losing their flexibility and becoming disadvantageously brittle. Additionally, they suffer other damage because they are handled repeatedly and, when splintering develops, will present a danger to those coming in contact with such flag sticks.

There remains a need for having flag sticks that do not suffer from the disadvantages of cracking and other forms of damage that occur on flag sticks presently used on golf courses.

### SUMMARY OF THE PRESENT INVENTION

The present invention is directed toward the use of a barrier for protecting poles or flag sticks, used on golf courses to mark the position of the hole in the golf course greens, from ambient environmental damage and damage that may occur from workers or golfers handling of such poles or flag sticks.

### DESCRIPTION OF THE PREFERRED EMBODIMENTS

In the preferred embodiment of the present invention, a heat shrinkable, synthetic tubular sheath is used as a protective barrier on golf course flag sticks. The heat shrinkable, synthetic tubular sheath encompasses the perimeter of the flag stick and extends over substantially the full length of said stick. Such tubular sheath is a thermo-shrinkable plastic film the composition of which is well known in the prior art. The synthetic heat shrinkable material is typically comprised of a common commercially available, polymeric substance such as polyvinyl chloride, polystyrene, polyethylene, polyester, rubber hydrochloride or it may be even obtained from the more exotic polymers such as the polyphenylene sulfides.

The important property of the tubular film of material herein is that it must contract in a direction perpendicular to the longitudinal axis when heat is applied, such contraction being sufficient to allow the film to adhere tightly to the flag stick. It is preferred that such contraction be from about 1.05 to about 4.5 times the diameter of the thermo-shrinkable tube prior to application of heat. Additionally, the thermo-shrinkable tube must not suffer any substantial longitudinal contraction in the heat-applied shrinking process. Preferably, it should decrease along the longitudinal axis by no more that 1% to about 15% of its length during the application of heat. Further, it must be of sufficient durability that it will not be easily torn or cut when in use. Heat shrinkable tubing that is made from polyvinyl chloride or polyethylene is preferred, with polyvinyl chloride being most preferred.

The flag sticks or poles to which the heat-shrinkable tubular material is applied are commonly made from a fiberglass (sometimes wood) shaft with a metal ferrule attached to the end of the pole. The ferrule fits snugly into an internal receptacle in the cup (the “cup” is a cylindrical, metallic structure, about 4½ inches in diameter and 6 inches in length, having an internal receptacle into which the flag stick can be inserted and secured. It is buried in the green but open at the top). The top of the flag stick terminates in a metal top-stud. It is this top-stud that is used to attach the flag that allows the flag stick to be readily observed as a golfer approaches the green.

In the preferred embodiment of this invention, the heat shrinkable, tubular barrier plastic is slipped over the flag stick, covering substantially the entire exposed surface from the metal ferrule at the bottom of the flag stick to the metal topstud at the top. Sufficient heat is then applied, such as from a heat gun or, if in the field, from a portable blower or other heat source, so that the tubular film contracts perpendicularly to the longitudinally axis and tightly encompasses the flag stick.

It should be noted that heat-shrinkable films are also available in sheet form. In some cases it may be advantageous to wrap a flag stick with such heat shrinkable sheet, adhering the edges of the sheet with a suitable adhesive. As in the case of the heat-shrinkable tubular material, application of heat will cause the wrapping to contract and tightly adhere to the flag stick.

The following examples represent an embodiment of the present invention. They are provided for the purpose of illustration only and should not be regarded as limiting the invention in any way.

### EXAMPLES

The poles employed in the following examples are flag sticks that are commonly used on golf courses throughout the United States and elsewhere to mark the position of the hole, i.e., the “cup”, located on each of the greens on a golf course. The sticks used in these examples were 7 foot long fiberglass, regulation flag sticks. They were painted white and carried a red flag at the top. There are numerous manufacturers for these items. These were purchased from Par Aide Manufacturing.

### Example 1

Seventeen previously used flagsticks were covered with a white, heat shrinkable polyethylene tubing (manufactured by Insultab, Woburn, Mass.) from slightly above the metal ferrule base to slightly below the metal top-stud. As applied to the flag sticks, the heat shrinkable tubing was slightly larger in diameter than the flag stick and readily slipped onto the stick. After being heated (by the application of heat from a heat gun), the tubing contracts (shrinks) along its entire length, and tightly adheres to the stick.

In carrying out this experiment, an identical flag stick was employed for comparison purposes that was identical to the seventeen sticks having the barrier comprised of the synthetic plastic material that had been shrunk by application of heat. The comparative stick had a white painted surface but no protective film. The eighteen sticks were inserted in cups around an 18 hole, regulation commercial golf course. The course was in normal use over the period of this study. The sticks were collected every evening and stored over night in an equipment shed. Early the following morning, the flag sticks were again placed around the golf course. The location of any individual flag stick around the golf course was varied from day to day in order to minimize any site-specific environmental effects that the individual sticks might be exposed to. The study ran for a period of 180 days and the sticks were exposed periods of rain, sleet and sunshine as well as temperatures that ran from a low in the lower 30's (° F.) to highs that were in the 80's. At the conclusion of this period, each stick was evaluated visually and physically to determine the extent of damage suffered over the time of this study.

At the conclusion of the study period, a visual examination of the unprotected flag stick and those protected by the heat shrinkable tubing was carried out. The unprotected flag stick showed signs of weathering and use. Numerous scratches and scuff marks were visible. The painted surface showed peeling and flaking at various places along the length of the stick. Some cracks were observed. The stick was quite stiff and its lack of flexibility was apparent. The stick could not be recommended for further use on the golf course. All of the flag sticks having the heat shrunk protective barrier showed almost no scuff and or scratch marks. Their color appeared to be as bright as when first placed in service on the course. Physical examination, by flexing the sticks indicated no decrease in flexibility from that noted at the beginning of the study (there was no increase in brittleness and or incipient fracture and breaking).

It was clear that the treated flag sticks had an extended life over the comparative flag stick and could be again placed around the golf course for further use.

### Example 2

To determine whether a flag stick bearing two different barrier heat shrinkable films was of similar durability and use as those having the single, white heat shrinkable barrier as demonstrated in the above Example 1, a second set of flag sticks were employed having a red colored heat shrinkable synthetic tubing on the top half of the stick and a white colored heat shrinkable tubing on the bottom half of the stick. In all other respects, this Example repeated the experimental conditions used for the sticks in Example 1.

As observed in Example 1, at the conclusion of the study period, the unprotected flag stick showed signs of weathering and use. Numerous scratches and scuff marks were visible on the stick. The painted surface showed peeling and flaking at various places along the length of the stick. Some cracks were observed. The stick was quite stiff and its lack of flexibility was apparent. The stick could not be recommended for further use on the golf course. All of the flag sticks being half of which was covered by the red colored heat shrunk protective barrier and the other half by a white shrinkable protective barrier showed almost no scuff and or scratch marks. The colors appeared to be as bright as when first placed in service on the course. Physical examination, by flexing the sticks indicated no decrease in flexibility from that noted at the beginning of the study (there was no increase in brittleness and or incipient fracture and breaking).

Similar to the conclusion of Example 1, this Example showed that the treated flag sticks had an extended life over the comparative flag stick and could be again placed around the golf course for further use.

I claim:

1. A protective barrier for a golf course flag stick comprising
a heat shrinkable, synthetic tubular sheath encompassing the perimeter of the flag stick and extending over substantially the full length of said stick, the heat shrinkable synthetic tubing being shrunken by applying heat so that it contracts over its said full length so as to tightly enclose said stick and form said protective barrier around said flag stick.

2. The protective barrier according to claim 1 wherein said contraction is from about 1.05 to about 4.5 times the diameter of the tube prior to application of heat.

3. The protective barrier according to claim 1 wherein said synthetic tubular sheath does not suffer any substantial longitudinal contraction in the shrinking process.

4. The protective barrier according to claim 3 wherein the contraction along the longitudinal axis is no more that 1% to about 10% of its length prior to application of heat.

5. The protective barrier according to claim 1 wherein said heat shrinkable tubing comprises polyvinyl chloride or polyethylene.

6. The protective barrier according to claim 5 wherein said heat shrinkable tubing is comprised of polyvinyl chloride.
